(19) United States
(12) Patent Application Publication
(10) Pub. No.: US 2011/0250373 A1
(43) Pub. Date: Oct. 13, 2011

(54) POLYMERIZATION CONTROLLERS FOR ORGANIC PEROXIDE INITIATOR CURED COMPOSITES

(75) Inventors: Thomas H. Kozel, Pottstown, PA (US); Michael O. Wells, Sinking Spring, PA (US)

(73) Assignee: Arkema Inc., King of Prussia, PA (US)

(21) Appl. No.: 13/140,497

(22) PCT Filed: Nov. 24, 2009
(86) PCT No.: PCT/US09/65622

§ 371 Date: Jun. 17, 2011

Related U.S. Application Data
(60) Provisional application No. 61/138,225, filed on Dec. 17, 2008.

(51) Int. Cl. B32B 1/08; C08F 36/04; C08F 20/10; C09K 3/00; C08F 18/04

(52) U.S. Cl. 428/36.9; 252/182.14; 526/193

(57) ABSTRACT

The use of nitroxides to control free radical cured resin systems used in the production of thermosetting materials such as in vacuum infusion, resin transfer molding and cured in place piping systems is disclosed. The invention could also be employed in other resin systems where control of kinetics would be desirable such as in adhesive formulations, in solid surface composites, and certain types of polyester casting resins.

### FIELD OF THE INVENTION

The present invention relates to the control of curing thermosetting resin compositions with radical initiators. More particularly, the present invention relates to the use of an organic peroxide formulation which includes a peroxide, a nitroxide and a diluent (reactive or non-reactive) to control free radical cured systems such as vacuum infusion, resin transfer molding and cured in place piping systems.

### DESCRIPTION OF RELATED ART

Typical peroxide based curing systems for vacuum infusion systems make use of a resin system that is pre-promoted with the peroxide added at room temperature and the curing reaction proceeding at a rate governed by the particular peroxide system and any inhibiting components added. Control of such systems is limited to selecting an appropriate peroxide initiator system and inhibitor components.

Premature curing during the preparatory phase is a difficulty in the use of free radical compounds in curing of thermosetting materials. By free radical compounds or radical initiators we include molecules that can produce radical species under mild conditions and promote radical polymerization reactions. Peroxides are the preferred free radical compounds. The preparatory phase generally consists of blending the constituents and forming them. The operating conditions of this preparatory phase quite often lead to decomposition of the peroxide initiator, thus inducing the curing reaction before the resin completely infuses and wets-out the system. The premature curing leads to imperfections of the final product.

Several solutions have been proposed to overcome this drawback. It has been proposed to use an initiator with a longer half-life at high temperature. The drawbacks of this approach are the low production efficiency due to a long curing time and the high energy costs. Traditionally, anti-oxidants have been used as preparatory phase stabilizers. These materials include butylated hydroxytoluene (BHT), hydroquinones and derivatives, and catechols. These materials all work by capturing the free radicals generated from peroxide decomposition, and converting them into a stable and unreactive form. The penalty from using too much of these materials is that over time, radicals produced are lost from the system by absorption into the “radical scavengers” also called inhibitors. This irreversible inhibition reduces the number of radicals available for cure.

It has also been proposed to incorporate certain additives in order to reduce the polymerization tendency. Thus, the use of a mixture of two different inhibitors, one of which is 2,2,6,6-tetramethyl 1-1-piperidinyloxy (TEMPO) as inhibitors for free radical polymerizations of unsaturated monomer was described in U.S. Pat. No. 6,660,181. The use of TEMPO to stabilize ethylenically unsaturated monomer or oligomer compositions from premature polymerization is disclosed in U.S. Pat. No. 5,290,888. The primary drawback to TEMPO and TEMPO derivatives are the high temperature of equilibrium. The use of TEMPO in full styrenic resins is limited due to the high reaction temperatures needed to, overcome the equilibrium temperature of the TEMPO-styrene adduct.

However, the prior use of additives are directed at inhibiting the curing of unsaturated composite resins and not at controlling the temperature and speed of curing unsaturated composite resins.

### SUMMARY OF THE INVENTION

The present invention makes it possible to control the crosslinking of thermosetting resins such that the curing reaction occurs at two distinct temperatures, one lower than the other. The multi-temperature curing system of the present invention allows a first low temperature to provide a low viscosity, pre-initiated resin system which will quickly infuse and wet-out a matrix such as fiberglass. The second higher temperature can thereafter be used for final curing of the system. This is achieved by using unique combination of a low active oxygen peroxide, a nitroxide control agent and a non-reactive diluent.

One aim of the present invention is to provide a thermoset resin polymerization control composition comprising at least one nitroxide and at least one peroxide free radical source and a non-reactive diluent. The nitroxide is preferably used in weight proportions ranging from 1:0.001 to 1:0.5 and advantageously between 1:0.01 and 1:0.25::peroxide:nitroxide and the diluent is preferably used in a weight proportion ranging from 1 to 50 wt % of the formulation.

In the manufacture of unsaturated polyester and vinyl ester resins, a small amount of a traditional antioxidant inhibitor is typically added to prevent premature polymerization and improve the resins shelf life. However, these must be used sparingly as inhibitors have the tendency to slow down the reactivity of the resin once the user wants it to cure. An added benefit to the use of the nitroxide within the polyester resin is that it will impart an additional level of storage stability without affecting the reactivity of the resin during cure.

to The present invention also provides molded or pultruded articles such as vacuum infusion, resin transfer molding and cured in place piping made with a crosslinking combination comprising peroxides, nitroxides and a non-reactive diluent.

### DETAILED DESCRIPTION OF PREFERRED EMBODIMENTS

The primary resins used in composites, such as vacuum infusion, resin transfer is molding and cured in place piping are polyester and vinyl ester. These resins are used in over 95% of the total composites production worldwide. The present invention is directed towards a three part paste system comprising a peroxide, a nitroxide control agent and a reactive or non-reactive diluent. The diluent serves to transform the difficult to use solid peroxide/nitroxide combination into an easily handled paste. The zo diluent also provides for easier and safer handling of the peroxide component. Selection of either a reactive or no-reactive diluent is dependant on the application.

The compounds, which may be used as free-radical initiators for the composites include compounds such as organic peroxides, which, upon thermal decomposition, produce free radicals which facilitate the curing/crosslinking reaction. Suitable organic peroxides include, but are not limited to, diacyl peroxides, peresters, peroxydicarbontates and mixtures thereof. Among the free-radical initiators used as crosslinking agents, low active oxygen diacyl peroxide initiators are preferred. A detailed description of these compounds is found in Encyclopedia of Chemical Technology, 3rd edition, vol. 17, pages 27 to 90 (1982).

Specific examples of diacyl peroxides include benzoyl peroxide, dilauroyl peroxide, didecanoyl peroxide, diacetyl peroxide, and di(3,5,5-trimethylhexanoyl) peroxide. A particularly preferred diacyl peroxide is dilauroyl peroxide such as Luperox® LP available from Arkema Inc., Philadelphia, Pa.

The present invention is especially applicable to aqueous dispersions of diacyl peroxides that are useful as initiators in the free radical polymerization of ethylenically unsaturated materials in bulk.

The initiation of the crosslinking of the composite materials by the peroxide occurs by standard mechanisms. The nitroxides modify the reactivity of the propagating polymer chains by acting to ‘cap’ the propagating radical at a temperature below the temperature of equilibrium defined by the nitroxide-monomer pair. Above the equilibrium temperature of the nitroxide-monomer pair, the nitroxide dissociates and the propagating radical becomes active again in polymer chain propagation. The net effect of this is that at ambient temperatures, the nitroxide stops polymer chain propagation and in effect acts to inhibit the reaction. In contrast to a true inhibitor, the nitroxide only caps the radical, as the active radical forms again upon heating. Once the dissociation temperature of the nitroxide monomer pair has been reached, the polymer chain begins to propagate in a controlled fashion governed by the equilibrium kinetics of the nitroxide. This differs from a true inhibitor in that the radical remains “stored” for use at a specific temperature whereas an inhibitor converts the radical into a permanently inactive species. In addition, the nitroxide will trap early formed radicals at temperatures below its activation temperature thus allowing the resin to be infused at elevated temperature without fear of premature curing. Once the temperature is elevetated above the nitroxide activation temperature, final curing occurs. Furthermore, the nitroxide also keeps the curing process going after the peroxide is consumed allowing for a complete, controlled rate cure.

The combination of a peroxide initiator, a nitroxide controller and a diluent in accordance with the present invention allows the user to formulate an organic paste initiator/controller system particularly suited for use in composite system applications. Use of the combination of the present invention provides an initiator/controller system that exhibits long-term stability at room temperature, but retains very good reactivities at two separate, elevated temperatures. The unique nitroxides of the present invention disassociate at considerably lower temperatures than prior art nitroxide inhibitors. Thus, the unique nitroxides of the present invention provide for stability at room temperatures but disassociate at normal composite forming/molding temperatures allowing crosslinking control. Furthermore, the disclosed nitroxides also allow for the use of a wide variety of reactive monomer classes including styrenics, acrylics, acrylamides, dienes, vinylics and mixtures thereof as will be evident to those skilled in the art.

The crosslinking control component of the present invention is a β-substituted stable free radical (nitroxide) type of the formula:

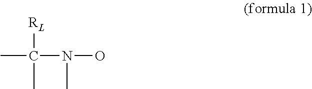

in which the R_{L} radical has a molar mass greater than 15. The monovalent R_{L} radical is said to be in the β position with respect to the nitrogen atom of the nitroxide radical. The remaining valencies of the carbon atom and of the nitrogen atom in the formula (1) can be bonded to various radicals such as a hydrogen atom or a hydrocarbon radical, such as an alkyl, aryl or aralkyl radical, comprising from 1 to 10 carbon atoms. The carbon atom and the nitrogen atom in the formula (1) may be connected to one another via a bivalent radical, so as to form a ring. However, the remaining valencies of the carbon atom and of the nitrogen atom of the formula (1) are preferably bonded to monovalent radicals. The R_{L} radical preferably has a molar mass greater than 30. The R_{L} radical can, for example, have a molar mass of between 40 and 450. The radical R_{L} can, by way of example, be a radical comprising a phosphoryl group, the R_{L} radical may be represented by the formula:

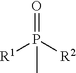

in which R¹ and R², which can be the same or different, can be chosen from alkyl, cycloalkyl, alkoxy, aryloxy, aryl, aralkyloxy, perfluoroalkyl and aralkyl radicals and can comprise from one to 20 carbon atoms. R¹and/or R² can also be a halogen atom, such as a chlorine or bromine or fluorine or iodine atom. The R_{L}, radical can also comprise at least one aromatic ring, such as the phenyl radical or the naphthyl radical, the latter may be substituted, for example by an alkyl radical comprising from one to four carbon atoms.

By way of example, the stable free radical can be chosen from: tert-butyl 1-phenyl-2-methylpropyl nitroxide; tert-butyl 1-(2-naphthyl)-2-methylpropyl nitroxide; tert-butyl 1-diethylphosphono-2,2-dimethylpropyl nitroxide; tert-butyl 1-dibenzylphosphono-2,2-dimethylpropyl nitroxide; phenyl 1-diethylphosphono-2,2-dimethylpropyl nitroxide; phenyl 1-diethylphosphono-1-methylethyl nitroxide; 1-phenyl-2-methylpropyl 1-diethylphosphono-1-methylethyl nitroxide.

A preferred β-substituted nitroxide is a β-phosphorous of the formula:

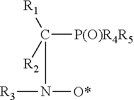

in which R₁ and R₂, which are identical or different, represent a hydrogen atom, a linear, branched or cyclic alkyl radical having a number of carbon atoms ranging from 1 to 10, an aryl radical, or an aralkyl radical having a number of carbon atoms ranging from 1 to 10, or else R₁ and R₂ are connected to one another so as to form a ring which includes the carbon atom carrying said R₁ and R₂ said ring having a number of carbon atoms, including the carbon carrying the R₁ and R₂ radicals, ranging from 3 to 8; R₃ represents a linear or branched and saturated or unsaturated hydrocarbonaceous radical which can comprise at least one ring, said radical having a number of carbon atoms ranging from 1 to 30; and R₄ and R₅, which are identical or different, represent a linear or branched alkyl radical having a number of carbon atoms ranging from 1 to 20 or a cycloalkyl, aryl, alkoxyl, aryloxyl, aralkyloxyl, perfluoroalkyl, aralkyl, dialkyl- or diarylamino, alkylarylamino or thioalkyl radical, or else R₄ and R₅ are connected to one another so as to form a ring which includes the phosphorus atom, said heterocycle having a number of carbon atoms ranging from 2 to 4 and being able in addition to comprise one or more oxygen, sulfur or nitrogen atoms. Methods of preparing this class of preferred β-phosphorous nitroxides are disclosed in U.S. Pat. Nos. 6,624,322 and U.S. Pat. No. 6,255,448.

Most preferably, the nitroxide is a β-phosphorous of the formula

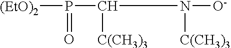

known as SG1.

An example of a non-reactive diluent is epoxidized soybean oil available as Vikoflex® 71710 from Viking Chemicals Inc., Bloomington, Minn.

The combination of a peroxide initiator system, a nitroxide controller and a non-reactive diluent of the present invention allows the user to formulate resin compositions that exhibit long stability at room temperature but very good reactivities at two distinct, elevated temperatures.

### EXAMPLES

### Example 1

Varying levels of the SG1 nitroxide along with a fixed loading of Luperox® LP peroxide. The peroxide charge was 50 wt % while the SG1 loading was varied from 0 to 2 wt %. Table 1 summarizes the gel time at 170° F. and the Barcol hardness of the end product

TABLE 1

| | SG1 Con., | Gel Time | Barcol |
|---|---|---|---|
| Experiment | wt % | @170° F., Min. | Hardness |
| 1 | 0.0 | 22:32 | 0 |
| 2 | 1.0 | 27:26 | 15-20 |
| 3 | 1.5 | 25:40 | 20-25 |
| 4 | 2.0 | 32:15 | 20-25 |

1. A thermosetting resin polymerization initiating system comprising:
a radical initiator free radical polymerization initiator;
a β substituted nitroxide polymerization control agent; and
a diluent.

2. The thermosetting resin polymerization initiating system of claim 1 wherein said radical initiator free radical polymerization initiator is selected from the group consisting of diacyl peroxides, peresters, peroxydicarbonates and mixtures thereof.

3. The thermosetting resin polymerization initiating system of claim 2, wherein said diacyl peroxide is selected from the group consisting of benzoyl peroxide, dilauroyl peroxide, didecanoyl peroxide, diacetyl peroxide, di(3,5,5-trimethylhexanoyl) peroxide and mixtures thereof.

4. The thermosetting resin polymerization initiating system of claim 1 wherein said β substituted nitroxide polymerization control agent is of formula

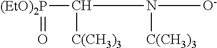

5. The thermosetting resin polymerization initiating system of claim 1 wherein said diluent is non-reactive.

6. A thermosetting resin combination comprising:
a resin;
a radical initiator free radical polymerization initiator;
a β substituted nitroxide polymerization control agent; and
a diluent.

7. The thermosetting resin combination of claim 6 wherein said resin is selected from the group consisting of unsaturated polyester resins, vinyl ester resins, dicyclopentadiene resins and mixtures thereof.

8. The thermosetting resin combination of claim 6 wherein said radical initiator free radical polymerization initiator is selected from the group consisting of diacyl peroxides peresters, peroxydicarbonates and mixtures thereof.

9. The thermosetting resin combination of claim 8, wherein said diacyl peroxide is selected from the group consisting of benzoyl peroxide, dilauroyl peroxide, didecanoyl peroxide, diacetyl peroxide, and di(3,5,5-trimethylhexanoyl) peroxide and mixtures thereof.

10. The thermosetting resin polymerization initiating system of claim 6 wherein said diluent is non-reactive.

11. The thermosetting resin combination of claim 6 wherein said β substituted nitroxide polymerization control agent is of formula

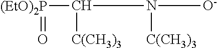

12. A cured in place resin pipe system comprising
a thermosetting resin and a polymerization initiating system comprising:
a radical initiator free radical polymerization initiator;
a β substituted nitroxide polymerization control agent; and
a diluent.

13. An infusion formed resin component comprising
a thermosetting resin and a polymerization initiating system comprising:
a radical initiator free radical polymerization initiator;
a β substituted nitroxide polymerization control agent; and
a diluent.

14. The thermosetting resin combination of claim 7 wherein:
said radical initiator free radical polymerization initiator comprises dilauroyl peroxide;
said substituted nitroxide polymerization control agent comprises 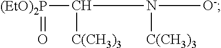
and
said diluent comprises epoxidized soybean oil.

15. The thermosetting resin polymerization initiating system of claim 1, wherein:
said radical initiator free radical polymerization initiator comprises dilauroyl peroxide;
said substituted nitroxide polymerization control agent comprises 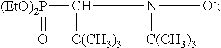
and
said diluent comprises epoxidized soybean oil.

16. The thermosetting resin polymerization initiating system of claim 1, wherein:
said radical initiator free radical polymerization initiator comprises an organic peroxide; and
said substituted nitroxide polymerization control agent comprises [chemical structure]
